(19) United States
(12) Patent Application Publication
(10) Pub. No.: US 2012/0126977 A1
(43) Pub. Date: May 24, 2012

(54) ALARM SYSTEM HAVING AN INDICATOR LIGHT THAT IS EXTERNAL TO AN ENCLOSED SPACE FOR INDICATING AN INTRUSION INTO THE ENCLOSED SPACE AND A METHOD FOR INSTALLING THE ALARM SYSTEM

(76) Inventors: Yael Debra Kellen, Teaneck, NJ (US); Arl Saul Kellen, Teaneck, NJ (US)

(21) Appl. No.: 12/949,730

(22) Filed: Nov. 18, 2010

(51) Int. Cl. G08B 13/00; B23P 11/00

(52) U.S. Cl. 340/541; 29/428

(57) ABSTRACT

An alarm system having an indicator light that is external to an enclosed space for indicating intrusion into the enclosed space, and a method for installing the alarm system, are disclosed. The alarm system detects an intrusion into the enclosed space, the intrusion thereby causing an indicator light outside the enclosed space to illuminate, thereby indicating that intrusion has occurred. The enclosed space can be an entire building, or a particular section or room of a building. At least one interior sensor is located within the enclosed space, and is configured to generate an intrusion signal in response to movement therein, while the indicator light is located outside the enclosed space, and within an outer perimeter zone of the enclosed space. Upon receiving the intrusion signal, the indicator light emits light that is visible from outside the outer perimeter zone of the enclosed space.

### CROSS-REFERENCE TO RELATED APPLICATIONS

This application is the Parent Application of application Ser. No. ______, entitled “Alarm System Having An Indicator Light That Is External To An Enclosed Space For Indicating The Time Elapsed Since An Intrusion Into The Enclosed Space And A Method For Installing The Alarm System,” and filed on ______.

This application is also the Parent Application of application Ser. No. ______, entitled “Alarm System Having An Indicator Light That Is External To An Enclosed Space For Indicating The Specific Location Of An Intrusion Into The Enclosed Space And A Method For Installing The Alarm System,” and filed on ______.

### FIELD

The invention relates generally to systems and methods for intruder detection, and more particularly to notification of an intruder detection event.

### BACKGROUND

Security systems for protecting buildings and other structures from intrusion are well known in the art. Such security systems generally include one or more alarms to notify others of an attempted or actual intrusion. These alarms can include audible signals and/or lights to indicate when a breach or attempted breach of a structure, such as the prying open of a door or window, has occurred. Such security systems can help to protect building owners and/or inhabitants from would-be intruders and actual intruders, such as burglars.

While many of these systems activate alarms to notify others of attempted or successful intrusions, these systems typically do not provide information as to whether there was merely an attempted intrusion, or an actual intrusion. Other systems may activate an alarm only to indicate an actual intrusion, but the alarm may deactivate or may be deactivated before the user of the system arrives upon the scene of the intrusion.

Furthermore, without sound, the alarms of known alarm systems are not easily noticeable from outside an enclosed space that was intruded upon. For example, the alarms of some systems are small, inconspicuous, and silent panels of information about an intrusion. Still other alarms that do provide sound do not clearly identify and locate the enclosed space that was intruded upon. Even though a loud alarm may be activated upon intrusion, the general location of the enclosed space being intruded upon may be unclear or ambiguous to observers outside the enclosed space.

### SUMMARY

An alarm system with an indicator light that is external to an enclosed space for indicating an intrusion into the enclosed space, and a method of installing such a system, are claimed. The system can be purchased and installed inexpensively and easily, and it can provide a signal that does not terminate until terminated by the user of the alarm system, and is easily recognizable to the user of the system upon the user's arrival upon or near the enclosed space. The signal indicates actual intrusion into the enclosed space, thereby warning the user and others of the potential of an intruder lurking and perhaps lying in wait, within the enclosed space.

Upon detecting an intrusion into the enclosed space, the alarm system employs an indicator light that is located within an outer perimeter zone that surrounds the enclosed space. Upon activation, the indicator light emits light that extends beyond the outer perimeter zone of the enclosed space as an intrusion alert, thereby not requiring a user of the alarm system to approach the enclosed space, or to carry any other dedicated device, to receive the alert. The alert is conspicuous and easily recognizable to anyone who approaches the outer perimeter zone of the enclosed space being intruded upon. An indicator light alarm is typically also easier for people to trace to its source than is a sound alarm, particularly if the enclosed space in question is situated close to other enclosed spaces with which it could be confused. The enclosed space can be a building, or a particular section of a building or a room within a building, for example.

The alarm system provides alerts for actual intrusion into an enclosed space and/or structure. The alert is specifically related to successful intrusions into an enclosed space. Such an alert can be helpful in a variety of ways, such as possibly discouraging the user or others investigating the intrusion from entering the enclosed space for safety reasons, and/or providing the user or others alerted to the intrusion with the impetus and motivation to call the police, for example. Alternatively, the intrusion alert can encourage others such as the police, or others qualified to closely investigate the intrusion, to enter the enclosed space.

In one embodiment, the invention is an alarm system for providing an indication of an intrusion into an enclosed space, the enclosed space being surrounded by an outer perimeter zone, the indication enabling an observer situated outside the outer perimeter zone to readily identify the enclosed space being intruded upon, the alarm system comprising: at least one interior sensor located within the enclosed space, one or more interior sensors being configured to generate an intrusion signal in response to an intrusion into the enclosed space; and an indicator light responsive to the intrusion signal, the indicator light being located outside the enclosed space and within an outer perimeter zone of the enclosed space, the indicator light being configured to emit light upon receiving the intrusion signal, the light being visible from outside the outer perimeter zone of the enclosed space, thereby rendering the enclosed space readily identified as having been intruded upon by an observer situated outside an outer perimeter zone of the enclosed space.

In another embodiment, the invention is a method for installing an alarm system for providing an indication of an intrusion into an enclosed space, the enclosed space being surrounded by an outer perimeter zone, the indication enabling an observer situated outside the outer perimeter zone to readily identify the enclosed space being intruded upon, the method comprising: mounting one or more interior sensor within an enclosed space, the one or more interior sensor being configured to generate an intrusion signal in response to a movement within the interior of the enclosed space; and mounting an indicator light responsive to the intrusion signal, the indicator light being located outside the enclosed space and within an outer perimeter zone of the enclosed space, the indicator light being configured to emit light upon receiving the intrusion signal, the light being visible from outside the outer perimeter zone of the enclosed space, thereby rendering the enclosed space readily identified as having been intruded upon by an observer situated outside a perimeter zone of the enclosed space.

In other embodiments, the at least one interior sensor is capable of detecting intrusion into the enclosed space in proximity to a peripheral window of the enclosed space, a peripheral door of the enclosed space, a chimney of the enclosed space, and/or a general internal area of the enclosed space.

In other embodiments, the enclosed space is a building, and the outer perimeter zone is a curtilage of the building. In still other embodiments, the enclosed space is a room of a building, and the outer perimeter zone is a section of the building. In other embodiments, the light is a focused light beam, a beacon light, a blinking light, and/or a rotating light.

In other embodiments, the intrusion signal is sent directly from the at least one interior sensor to the indicator light, thereby initiating activation of the indicator light. In other embodiments, the alarm system further includes a control system in communication with the at least one interior sensor and the indicator light, the control system being configured to receive the intrusion signal from the at least one intrusion detector, and send an activation signal to the indicator light, thereby initiating activation of the indicator light. In some embodiments, the intrusion signal is sent from the one or more sensor to the indicator light via electrical wiring, or wireless signaling.

In some embodiments, the intrusion signal is also received on a mobile device. In some embodiments, the system can be activated by a keypad installed near an entrance of the enclosed space, a keypad installed within the outer perimeter zone of the enclosed space, a manual key configured to fit a manual lock, a remote control device dedicated to activation of the system, and/or a personal mobile communication device.

### BRIEF DESCRIPTION OF THE DRAWINGS

The invention will be more fully understood by reference to the detailed description, in conjunction with the following figures, wherein:

FIG. 1 is a block diagram showing the main elements of an embodiment of the alarm system;

FIG. 2 is an elements diagram showing the interaction between the main elements of an embodiment of the alarm system wherein the main elements are hard wired together;

FIG. 3 is an elements diagram showing the interaction between the main elements of an alternative embodiment of the alarm system wherein the main elements are connected together via wireless communication;

FIG. 4 is an aerial view of a house equipped with an installed version of an embodiment of the alarm system;

FIG. 5 is an aerial view of a house equipped with an alternative embodiment of an indicator light of the alarm system;

FIG. 6 is an aerial view of a house equipped with another alternative embodiment of an indicator light of the alarm system;

FIG. 7 is an illustration of a component of an embodiment of the alarm system, wherein an intrusion message is produced on a mobile device;

FIG. 8 is an illustration of a room within a building employing an embodiment of the alarm system;

FIG. 9A depicts a keypad configured to control activating system for an embodiment of the alarm system;

FIG. 9B depicts a manual key and lock configured to control an activating system for an embodiment of the alarm system;

FIG. 9C depicts a remote dedicated device and receiver configured to control an activating system for an embodiment of the alarm system;

FIG. 9D depicts a personal mobile device and receiver configured to control an activating system for an embodiment of the alarm system; and

FIG. 10 is a flowchart depicting a sequence of events related to an embodiment of the alarm system in use.

### DETAILED DESCRIPTION

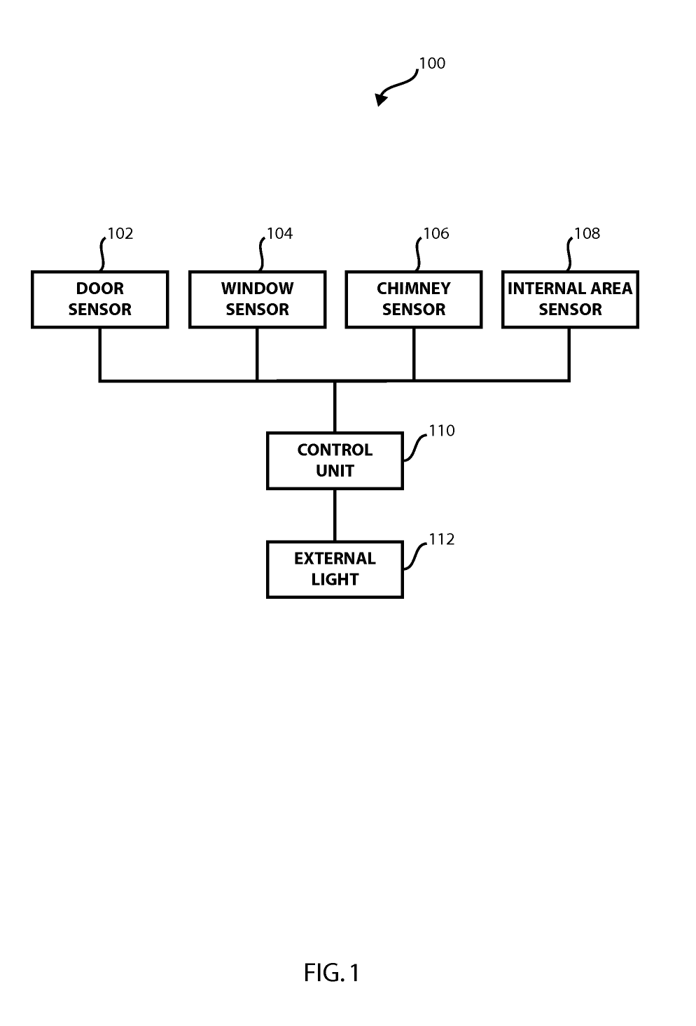

FIG. 1 is a block diagram showing the main elements of an embodiment of the alarm system. In the embodiment represented by the diagram of the system elements 100, several interior sensors are placed within an interior space of a building, which in this case is a house.

The enclosed space to be equipped with the alarm system can be any building or enclosed portion of a building (such as a section or room of the building) for which a user of the system wishes to receive notice of the intrusion by another into the enclosed space. Such enclosed space can include rooms, sections, or levels of buildings, or entire internal buildings such as houses, apartments, schools, dorm rooms, office buildings, factories, or any other buildings apparent to one of ordinary skill in the art of intrusion alert systems.

In the embodiment shown, the sensors are placed in such a manner so as to detect intrusion of the building. In alternative embodiments, sensors can be strategically placed so as to detect intrusion of a certain particular enclosed space of the building, such as a particular room or group of adjacent rooms, or an entire floor level of the building, for example. The exemplary sensors shown include a door sensor 102, a window sensor 104, a chimney sensor 106, and an internal area sensor 108.

Sensors can be placed in proximity to access points to the building or an enclosed portion of the building, so as to detect intrusion of the enclosed space through the access point. Such access points which the sensor may be placed near can include a door 102, window 104 or chimney 106, for example. Another sensor can be placed within a general internal area of an enclosed space 108, so as to detect movement inside the enclosed space, or so as to employ any other means of detecting intrusion apparent to one of ordinary skill in the art of intrusion detection.

The sensors can be any kind of sensor configured to detect intrusion, such as a heat sensor or infrared sensor, for example. One skilled in the art will appreciate and readily acknowledge other possible sensors which can be used. If an intrusion occurs, a sensor will detect the intrusion and send an intrusion signal to a control unit 110. The control unit 110 will send the intrusion signal to an indicator light 112 located outside the enclosed space and in an outer perimeter zone of the enclosed space. The indicator light will emit light so as to indicate that an intrusion has occurred. Other sensors positioned and configured to detect movement within the enclosed space for which intrusion is to be detected will be readily apparent to one ordinarily skilled in the art of intrusion detection.

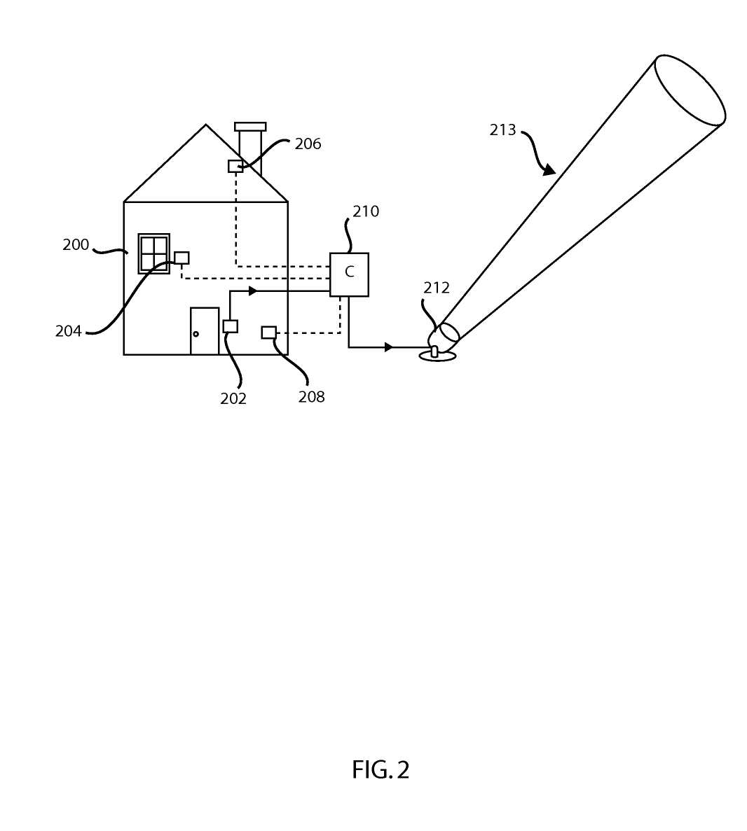

FIG. 2 is an elements diagram showing the interaction between the main elements of an embodiment of the alarm system, wherein the main elements are hard wired together with electrical wiring. A house 200 equipped with an embodiment of the alarm system is shown, containing a door sensor 202, window sensor 204, chimney sensor 206, and internal area sensor 208.

As depicted in this diagram, the sensors are hard wired to a common control unit 210, which in turn is in hard wire communication with an indicator light 212. In the embodiment shown, the control unit 208 is located outside the structure of the house 200. Upon receiving an intrusion signal from any of the sensors, the control unit 210 can propagate the signal to the indicator light 212 located in the outer perimeter zone of the enclosed space, which emits light 213 that is visible beyond the outer perimeter zone of the enclosed space, thereby alerting others to an intrusion. In this embodiment, the indicator light 212 is located outside the house but within a curtilage of the house 200, and produces light 213 that is visible beyond the curtilage.

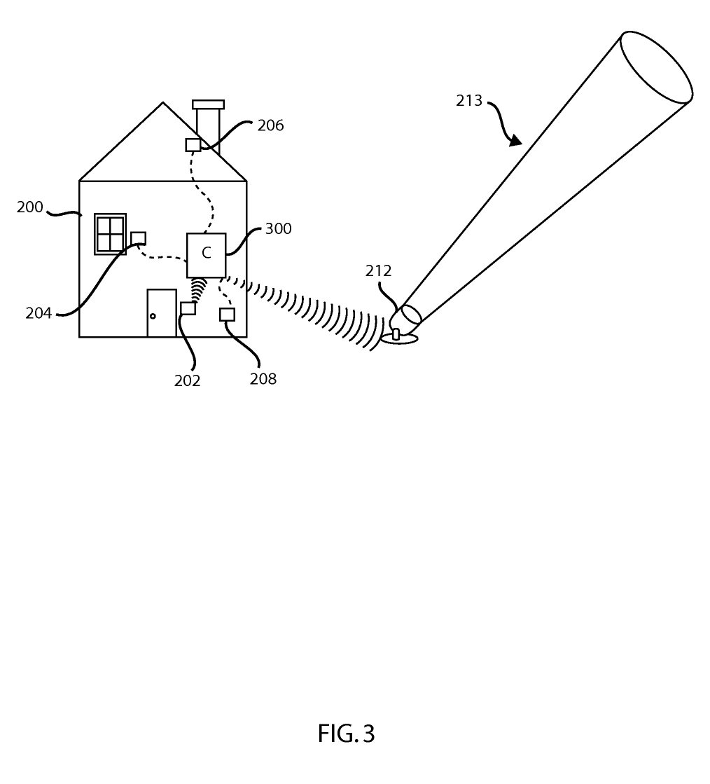

FIG. 3 is an elements diagram showing the interaction between the main elements of an alternative embodiment of the alarm system, wherein the main elements are connected together via wireless signaling. A house 200 equipped with an embodiment of the alarm system is shown, containing a door sensor 202, window sensor 204, chimney sensor 206, and internal area sensor 208.

As depicted in this diagram, the sensors are linked via wireless connection to a common control unit 300, which in turn is in wireless communication with an indicator light 212. In the embodiment shown, the control unit 300 is located inside the structure of the house 200. Upon receiving an intrusion signal from any of the sensors, the control unit 300 can propagate the signal to the indicator light 212 located in the outer perimeter zone of the enclosed space, which emits light 213 that is visible beyond the outer perimeter zone of the enclosed space thereby alerting others to an intrusion. In this embodiment, the indicator light 212 is located outside the house but within a curtilage of the house 200, and produces light 213 that is visible beyond the curtilage.

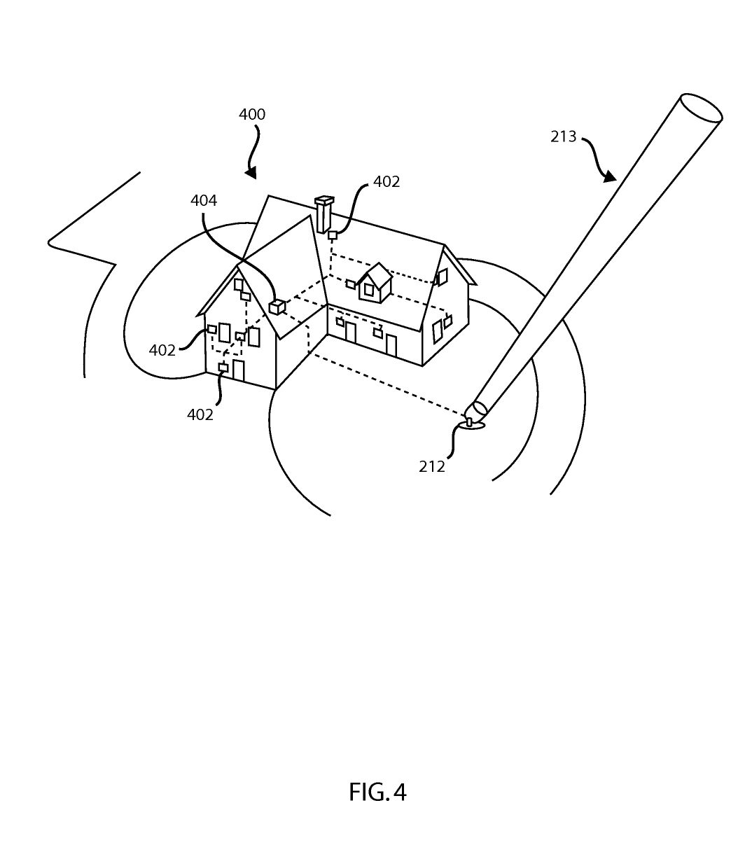

FIG. 4 is an aerial view of a house with an embodiment of the alarm system installed within the house. A house 400 is equipped with sensors 402 positioned on the interior of various access points of the house, all of which are connected to a control unit 404. The control unit 404 is then connected to an indicator light 212 which produces a light 213 located in the outer perimeter zone of the enclosed space, and visible beyond the outer perimeter zone of the enclosed space. In this embodiment, the light is a focused beam 213. In alternative embodiments, the light can be a diffuse light beam, or a beacon light. The focused beam 213 can have continuous output, or alternatively may have non-continuous output, such as in the case of a blinking light.

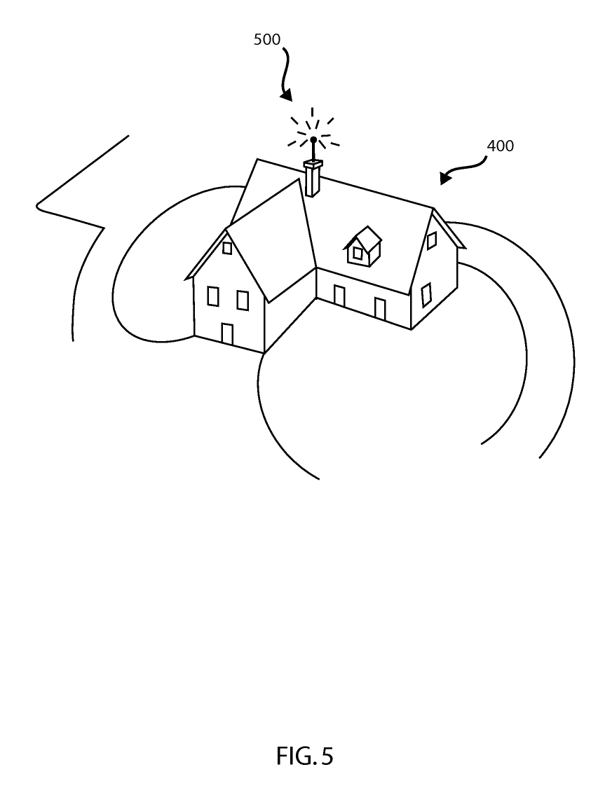

FIG. 5 is an aerial view of a house equipped with an alternative embodiment of an indicator light of the alarm system. In this embodiment, the house 400 is equipped with a beacon light 500, such as light emitted omni-directionally from a bulb, which is installed at the top of the house 400. The beacon light 500 can be a blinking light or other light of non-continuous output, or alternatively, it can be a light of continuous output.

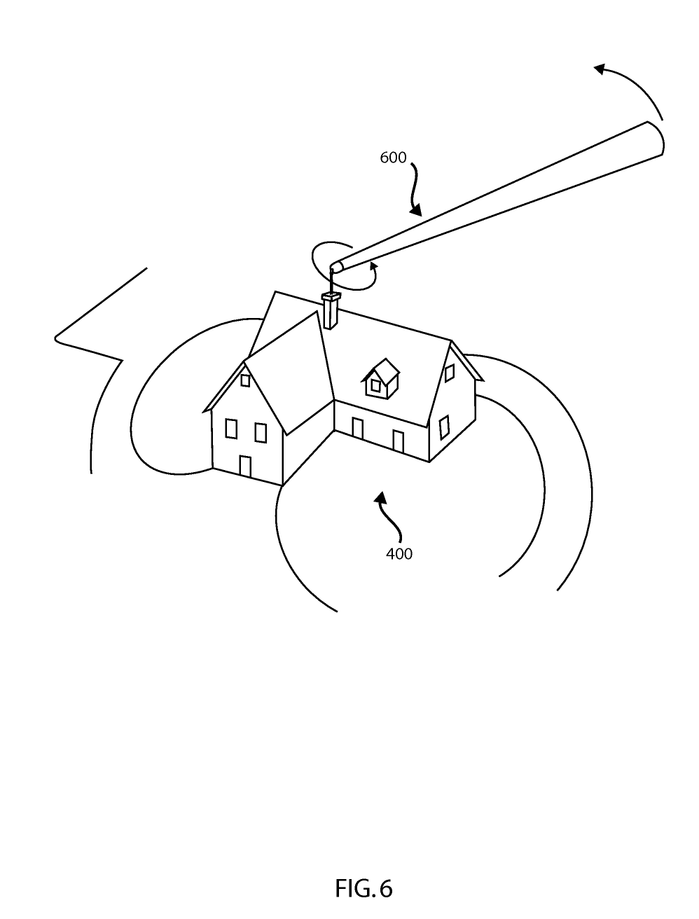

FIG. 6 is an aerial view of a house equipped with another alternative embodiment of an indicator light of the alarm system. In this embodiment, the house 400 is equipped with a rotating light beam 600, which is installed at the top of the house 400. The light beam 600 is projected substantially horizontally from a rotating light source. In the embodiment shown, the rotating light beam 600 is a focused light beam which rotates about the vertical axis of its light source. This rotating light 600 can potentially alert others in all directions beyond the curtilage of the house 400, potentially including those located within neighboring dwellings.

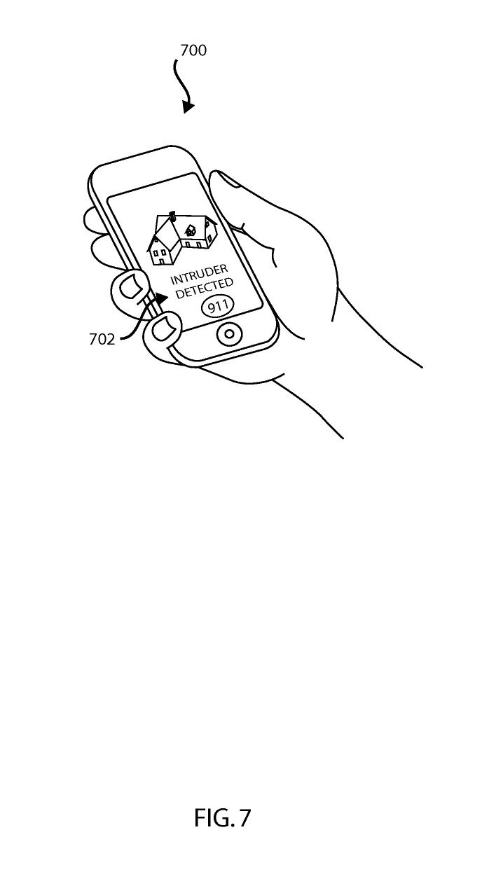

FIG. 7 is an illustration of a component of an embodiment of the alarm system, wherein a mobile device 700 receives an intrusion message 702, in addition to an indicator light signal being projected from the outer perimeter zone of the enclosed space with which the indicator light is associated. Such a mobile device intrusion message 702 can supplement the indicator light, providing an enhancement to the alarm system. For example, if an intrusion is detected, the alarm system can alert those for whom the intruded enclosed space is in sight. In addition, a user of the alarm system can receive an alert 702 on their mobile device 700, which can be an important and useful supplemental alert if and when they are not near or approaching the enclosed space.

FIG. 8 is an illustration of a room within a building employing an embodiment of the alarm system. In this embodiment, the alarm system is configured to alert others of an intrusion into an enclosed space within a building, in this instance the enclosed space being a room of a house. In this embodiment, a room 800 adjacent to the intruded room is equipped with an indicator light 802.

The indicator light 802 is located within the outer perimeter zone of the room equipped with the alarm system, and the indicator light 802 produces light that is visible beyond the outer perimeter zone of the room equipped with the alarm system. For example, someone in the adjacent room 800 could easily see the indicator light turn on. In some embodiments, several such indicator lights 802 may be placed at various locations within the outer perimeter zone of the enclosed space equipped with the alarm system, so as to alert others in various neighboring rooms, for example.

If an unexpected intrusion occurs in one room, the indicator light 802 can alert others in adjacent rooms 800 of the intrusion, for example. In other embodiments, the enclosed space under surveillance may be a group of rooms, or some other portion of a building, for example. The indicator light 802 is located in the outer perimeter zone immediately outside the enclosed space under surveillance. In this case, the outer perimeter zone includes the doorway 804 and wall of an adjacent room 800. The external light 802 is therefore mounted on the adjacent wall of the doorway 804 connecting the intruded room with the adjacent room 800.

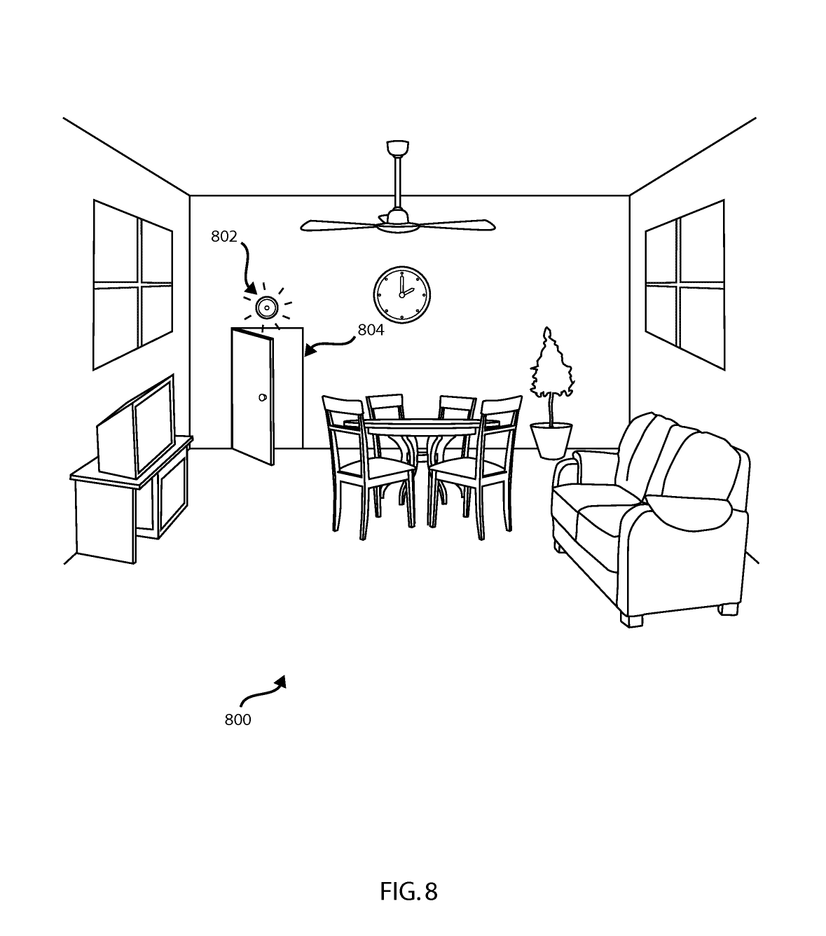

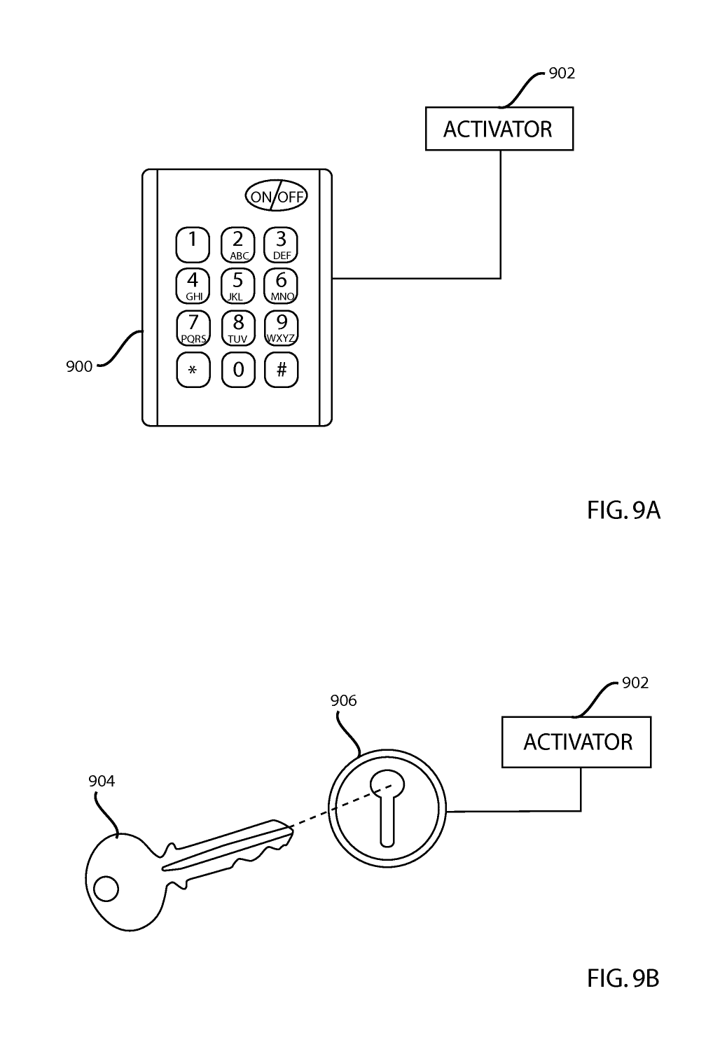

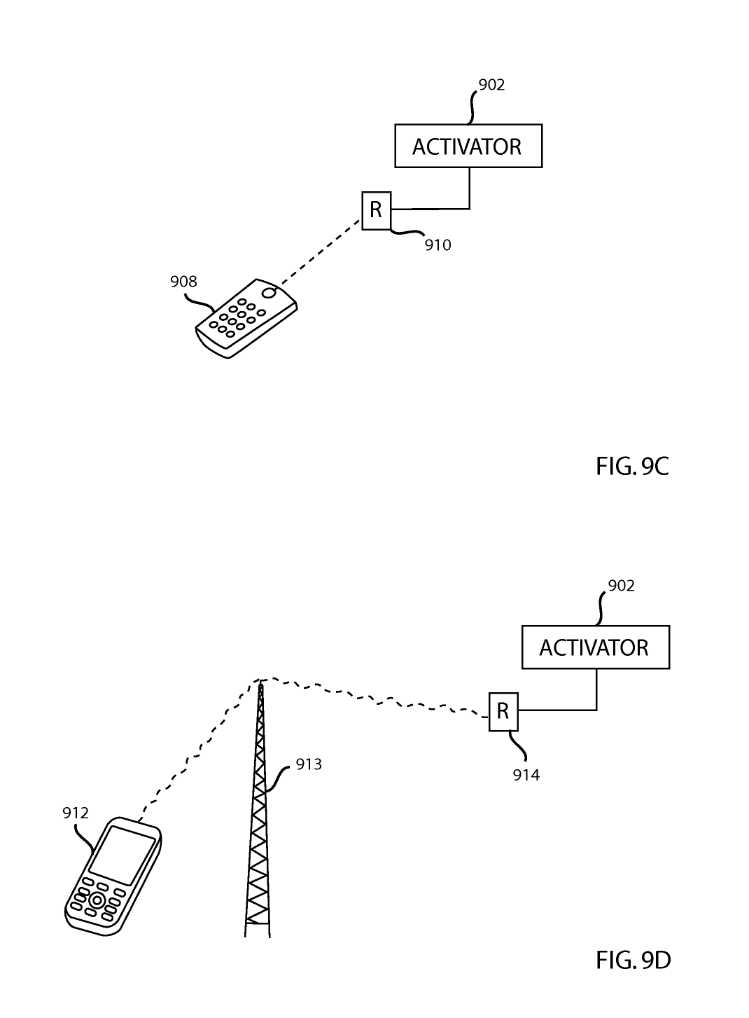

The alarm system can be activated through a variety of techniques, some of which are discussed explicitly in this specification, while still others will be readily apparent to one of ordinary skill in the art. FIG. 9A depicts a keypad 900 configured to control an activating system in an embodiment of the alarm system. Such a keypad can be installed on an outer wall of a house, near an entrance into the house for example, or somewhere near the house and within the curtilage of the house, for example. The keypad is connected to and capable of communicating with an activator 902 which can activate the system.

FIG. 9B depicts a manual key and lock configured to control an activating system for an embodiment of the alarm system. In this embodiment, a manual key 904 can fit into a manual keyhole 906, and whereupon the key 904 is inserted into the keyhole 906 and turned, the alarm system can be activated and/or deactivated via communication with an activator 902.

The alarm system can also be activated via remote devices. FIG. 9C depicts a dedicated remote device 908 and a receiver 910, which in combination are configured to control an activating system in an embodiment of the alarm system. A user of the system can activate the system using a remote control 908 which communicates with a receiver 910, which in turn is linked to an activator 902. FIG. 9D depicts a personal mobile device 912 and reception tower 913 in communication with a receiver 914, which in turn is linked to an activator 902 and configured to control an activating system for an embodiment of the alarm system. Still other activation systems will be readily apparent to one of average skill in the art.

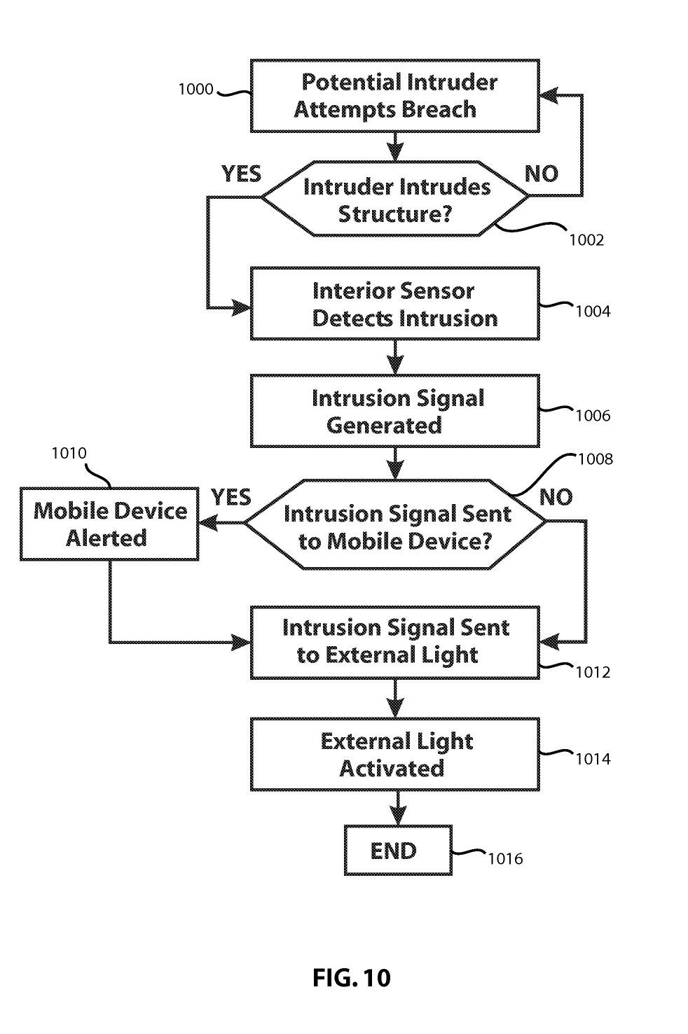

FIG. 10 is a flowchart depicting a sequence of events related to an embodiment of the alarm system in use, in relation to a structure. First, a potential intruder attempts to breach and/or intrude a structure or other enclosed space equipped with the system 1000, with intent to intrude the structure or enclosed space. In this embodiment, the entire structure is equipped with the system, while in alternative embodiments only a sub-enclosure, such as a room within the structure, might be so equipped.

If the intruder succeeds in intruding the structure 10002, an interior sensor will detect the intrusion 1004 and generate an intrusion signal 1006. If the system includes for the intrusion signal to be sent to a user's mobile device 1008, then the mobile device can be alerted 1010. The intrusion signal is sent to an indicator light 1012, which then activates and outputs an alarm light 1014 upon receiving the information regarding the intrusion signal. This completes the main operation of the system 1016.

Other modifications and implementations will occur to those skilled in the art without departing from the spirit and the scope of the invention as claimed. Accordingly, the above description is not intended to limit the invention except as indicated in the following claims.

What is claimed is:

1. An alarm system for providing an indication of an intrusion into an enclosed space, the enclosed space being surrounded by an outer perimeter zone, the indication enabling an observer situated outside the outer perimeter zone to readily identify the enclosed space being intruded upon, the alarm system comprising:
at least one interior sensor located within the enclosed space, the at least one interior sensor being configured to generate an intrusion signal in response to an intrusion into the enclosed space; and
an indicator light responsive to the intrusion signal, the indicator light being located outside the enclosed space and within an outer perimeter zone of the enclosed space,
the indicator light being configured to emit light upon receiving the intrusion signal, the light being visible from outside the outer perimeter zone of the enclosed space, thereby rendering the enclosed space readily identified as having been intruded upon by an observer situated outside an outer perimeter zone of the enclosed space.

2. The alarm system of claim 1, wherein the at least one interior sensor is capable of detecting intrusion into the enclosed space in proximity to at least one of:
a peripheral window of the enclosed space;
a peripheral door of the enclosed space;
a chimney of the enclosed space; and
a general internal area of the enclosed space.

3. The alarm system of claim 1, wherein:
the enclosed space is a building; and
the outer perimeter zone is a curtilage of the building.

4. The alarm system of claim 1, wherein:
the enclosed space is a room of a building; and
the outer perimeter zone is a section of the building.

5. The alarm system of claim 1, wherein the light is at least one of:
a focused light beam;
a beacon light;
a blinking light; and
a rotating light.

6. The alarm system of claim 1, wherein the intrusion signal is sent directly from the at least one interior sensor to the indicator light, thereby initiating activation of the indicator light.

7. The alarm system of claim 1, further comprising:
a control system in communication with the at least one interior sensor and the indicator light,
the control system being configured to receive the intrusion signal from the at least one intrusion detector, and send an activation signal to the indicator light, thereby initiating activation of the indicator light.

8. The alarm system of claim 1, wherein the intrusion signal is sent from the at least one interior sensor to the indicator light via one of:
electrical wiring; and
wireless signaling.

9. The alarm system of claim 1, wherein the intrusion signal is also received on a mobile device.

10. The alarm system of claim 1, wherein the system can be activated by at least one of:
a keypad installed near an entrance of the enclosed space;
a keypad installed within the outer perimeter zone of the enclosed space;
a manual key configured to fit a manual lock;
a remote control device dedicated to activation of the system; and
a personal mobile communication device.

11. A method of installing an alarm system for providing an indication of an intrusion into an enclosed space, the enclosed space being surrounded by an outer perimeter zone, the indication enabling an observer situated outside the outer perimeter zone to readily identify the enclosed space being intruded upon, the method comprising:
mounting at least one interior sensor within an enclosed space, the at least one interior sensor being configured to generate an intrusion signal in response to a movement within the interior of the enclosed space; and
mounting an indicator light responsive to the intrusion signal, the indicator light being located outside the enclosed space and within an outer perimeter zone of the enclosed space,
the indicator light being configured to emit light upon receiving the intrusion signal, the light being visible from outside the outer perimeter zone of the enclosed space, thereby rendering the enclosed space readily identified as having been intruded upon by an observer situated outside a perimeter zone of the enclosed space.

12. The method of claim 11, wherein the at least one interior sensor is capable of detecting intrusion into the enclosed space in proximity to at least one of:
a peripheral window of the enclosed space;
a peripheral door of the enclosed space;
a chimney of the enclosed space; and
a general internal area of the enclosed space.

13. The method of claim 11, wherein:
the enclosed space is a building; and
the outer perimeter zone is a curtilage of the building.

14. The method of claim 11, wherein:
the enclosed space is a room of a building; and
the outer perimeter zone is a section of the building.

15. The method of claim 11, wherein the light is at least one of:
a focused light beam;
a beacon light;
a blinking light; and
a rotating light.

16. The method of claim 11, wherein the intrusion signal is sent directly from the at least one interior sensor to the indicator light, thereby initiating activation of the indicator light.

17. The method of claim 11, further comprising:
a control system in communication with the at least one interior sensor and the indicator light,
the control system being configured to receive the intrusion signal from the at least one intrusion detector, and send an activation signal to the indicator light, thereby initiating activation of the indicator light.

18. The method of claim 11, wherein the intrusion signal is sent from the at least one interior sensor to the indicator light via one of:
electrical wiring; and
wireless signaling.

19. The method of claim 11, wherein the intrusion signal is also received on a mobile device.

20. The method of claim 1, wherein the system can be activated by at least one of:
a keypad installed near an entrance of the enclosed space;
a keypad installed within the outer perimeter zone of the enclosed space;
a manual key configured to fit a manual lock;
a remote control device dedicated to activation of the system; and
a personal mobile communication device.
